(19) United States
(12) Patent Application Publication
(10) Pub. No.: US 2002/0072936 A1
(43) Pub. Date: Jun. 13, 2002

(54) Children's income protection and benefit health insurance policy and method of underwriting the same

(76) Inventor: Jeffrey Marc Newman, Coral Springs, FL (US)

Correspondence Address: STEINBERG & RASKIN, P.C., 1140 AVENUE OF THE AMERICAS, 15th FLOOR, NEW YORK, NY, 10036-5803, US

(21) Appl. No.: 09/925,073

(22) Filed: Aug. 8, 2001

Related U.S. Application Data
(60) Provisional application No. 60/223,764, filed on Aug. 8, 2000.

(51) Int. Cl. G06F 17/60

(52) U.S. Cl. 705/4

(57) ABSTRACT

An individual health insurance policy providing benefits for children who become disabled and a method for underwriting the same, providing monetary benefits to cover the expenses associated with a disabling injury suffered by a child including care, supervision, schooling, incidental expense benefits, supplemental benefits, which include long term care and home tutoring benefits, and other benefits for a disabling event.

### BACKGROUND OF THE INVENTION

Wage-earning adults are in most cases their own primary source of monetary support. They use the wages they earn to provide themselves the necessities of life, including food, clothing, shelter, education, entertainment, and health care. Many wage-earning adults not only provide support for themselves, but also provide support, either partially or totally, for dependents including children, spouses and other family members. A problem for wage-earning adults has been how to maintain the ability to support themselves and their dependents should they become disabled. Disabilities can leave wage-earners either no longer able to work and earn a living or unable to work at a pre-disability level, resulting in their only being able to work at a diminished wage-earning capacity. Not only do disabilities undermine the ability to earn a living and provide for life's necessities, they often create large added expenses. Disabilities almost always require medical attention and sometimes major medical attention, resulting in large medical expenses. Further, certain disabilities may require the attention of an individual caregiver, either professional or a friend or family member. Beyond the obvious physical and mental hardships a disability may cause, it can be economically catastrophic to the wage-earner and his or her dependents.

To alleviate the economic problems associated with disability, as well as engage in a profitable business, insurance companies have underwritten policies for wage-earners who become disabled. Such policies provide payments for wages lost due to a disabling injury. They also provide payments for the health care requirements of the disabled. In doing so, such policies provide money to defray or cover the costs of a disability. These costs often include those that affect not only the actual disabled person, but those that affect the dependents of the disabled person, primly families, including spouses and children. Such policies do not cover the costs of a disabling injury suffered by a non-wage-earning member of a household, such as a minor child.

Traditionally, if a family wage-earner became disabled, disability insurance 1) replaced the income no longer generated by the wage earner and 2) covered the added expenses which accompany a disabling injury, including major medical costs, rehabilitation costs and the costs associated with professional caregivers. If a non-wage-earning family member, such as a minor child, became disabled, it was assumed that the wage-earning family members would provide for the expenses of the disabling injury. It was also assumed that other family members, often a non-wage earning parent, would act as caregivers to the disabled family member.

Currently, many households do not have a non-wage earning adult. In single and two parent households, the parents are employed and their wages are vital to the support of the family. This economic trend does not appear to be reversing in the foreseeable future. It is not economically feasible for a wage-earning parent to curtail his or her employment to act as a caregiver for a disabled child. Plus, it is economically difficult for most wage-earners to pay for a professional caregiver. Further, in light of today's exorbitant costs in the health care industry, it is also economically difficult, if not impossible, for a full-time wage-earner to cover major medical expenses and rehabilitation expenses in addition to providing for life's necessities for an entire family.

### SUMMARY OF THE INVENTION

It is an object of this invention to provide a method that helps to defray the costs associated with a disabling injury suffered by a minor child.

It is another object of this invention to provide a method which allows a wage-earner to retain his or her job while insuring that necessary care is available to a minor child who becomes disabled.

It is yet another object of this invention to provide a method of underwriting an insurance policy providing benefits for minor children who become disabled.

It is still another object of this invention to provide a method of underwriting an insurance policy providing benefits for children who become disabled that is fiscally and actuarially realizable for both the underwriter and the policy owner.

The invention is a method for the underwriting of an individual health insurance policy providing benefits for children who become disabled. The invention includes underwriting a policy providing monetary benefits to cover the expenses associated with a disabling injury suffered by a child. The needs of disabled minor children differ in many ways from those of a disabled adult. Disabled minor children require more care and supervision than adults who suffer from similar disabilities. Minor children also require schooling. A disability may make it impossible for a child to attend school and a school district may only provide limited at home or at hospital teaching. Thus, the benefits of a policy according to this invention may include incidental expense benefits, supplemental benefits, which include long term care and home tutoring benefits, and other benefits for a disabling event.

### DETAILED DESCRIPTION OF THE PREFERRED EMBODIMENT

I. Product Type

The preferred embodiment of this invention is a method of underwriting of a guaranteed renewable individual health insurance policy providing benefits for children who become disabled. Policy benefits consist of the Monthly Incidental Expense Benefit, payable beginning at Age 5, and the Additional Supplemental Benefits, which include long term care and home tutoring benefits and a Lump Sum Benefit for Major Disabling Event as defined in the policy.

Coverage is sold in units $100 of Monthly Incidental Expense Benefit, with a minimum of five units and maximum of thirty-four units offered. The Additional Supplemental Benefits provided are fixed and therefore do not vary by amount of Monthly Incidental Expense Benefit purchased.

Total benefits payable under the policy are subject to the $1,000,000 Policy Maximum Level Premium Structure

II. Level Premium Structure

Unisex level premiums are calculated as $25 per month for the minimum plan plus $1 per month for each additional $100 unit of Monthly Incidental Expense Benefit purchased. Premiums are guaranteed renewable to the policy anniversary following attainment of Age 21, or the policy anniversary following attainment of Age 25 if the Covered Insured is a Dependent of the Policy Owner and a Fulltime Student. Premium rates are the same for all ages and vary only by number of units of Monthly Incidental Expense Benefit purchased.

III. Issue Age Range

Coverage is available on an age-last birthday basis to Age 18, subject to underwriting approval and a minimum age of six months.

IV. Qualifying for Benefits

To qualify for policy benefits, except for the Lump Sum Benefit for Major Disabling Event, the Covered Insured must be Functionally Disabled or Presumptively Disabled as defined in the policy. The Lump Sum Benefit for Major Disabling Event is conditioned upon the Covered Insured incurring a Major Disabling Event as defined in the policy and surviving for 30 days.

V. Incidental Expense Benefit

The policy will pay the Monthly Incidental Expense Benefit for Injury or Sickness, which is first manifested after the Covered Insured's attainment of Age 5. This benefit is payable only if the Covered Insured is not gainfully employed.

This benefit will begin on the first day on which the Covered Insured is Functionally Disabled or Presumptively Disabled and will continue to be paid while the Covered Insured continues to be Functionally Disabled or Presumptively Disabled. For periods less than a month, the policy will pay 1/30^{th} of the benefit for each day the Covered Insured is eligible to receive this benefit.

VI. Additional Supplemental Benefits

The following additional policy benefits are provided:

A. Nursing Home Facility Benefit

Once a 20 Day Lifetime Elimination Period has been satisfied, the policy will pay a $100 Nursing Home Facility Daily Benefit for each day the Covered Insured is confined to a Nursing Home Facility. A Plan of Care must be provided.

B. Home Health Care Benefit

Once the 20 Day Lifetime Elimination Period has been satisfied, the policy will pay the $50 Home Health Care Daily Benefit for each day the Covered Insured received Home Health Care. A Plan of Care must be provided.

C. Home Tutoring Benefit

The policy will pay the $30 Home Tutoring Hourly Benefit for each hour the Covered Insured receives Home Tutoring up to a maximum of ten hours per week

D. Caregiver Training Benefit

The policy will pay the actual charges incurred to provide training to help a Family Member or others who care for the Covered Insured in the Covered Insured's Home learn how to provide necessary care. This benefit is limited to a lifetime actual amount of $1,000. A Plan of Care must be provided.

E. Supportive Equipment Benefit

The policy will pay the actual charges incurred for Supportive Equipment for the Covered Insured. This benefit is limited to a lifetime maximum amount of $10,000. A Plan of care must be provided.

F. Lump Sum Benefit for Major Disabling Event

The policy will pay a lump sum benefit of $25,000 after the Covered Insured incurs a Major Disabling Event provided that the following conditions are met: (1) the Major Disabling Event is first diagnosed, or in the event of a Major Organ Transplant, the surgical procedure is performed after the 30 day waiting period that begins on the Effective Date and (2) the Covered Insured survives for thirty (30) days following the date of the Major Disabling Event. This benefit is payable for only one Major Disabling Event during the Covered Insured's lifetime.

G. Rehabilitation Benefit

If the Covered Insured has received benefits under the Incidental Expense Benefit for at least three (3) consecutive months and returns to school or gainful employment, the policy will continue to pay the Monthly Incidental Expense Benefit for three months.

VIII. Extension of Benefits to Age 65

Termination of the policy will not affect the Covered Insured's claim for Nursing Home Facility Benefit or Home Health Care Benefits that begins while the policy is in force and continues without interruption beyond the date of termination. This extension of benefits, beyond the period the policy was in force, will continue through the Covered Insured's attainment of Age 65 and is subject to the $1,000,000 Policy Maximum, Conditions on Eligibility and all other applicable provisions of the policy.

IX. Policy Extensions

The policy will not pay benefits:

1. Due to normal pregnancy or childbirth; or

2. Caused by alcoholism or drug addiction; or

3. Caused by illness, treatment or medical conditions arising out of:

a. war or act of war, whether declared or undeclared); or

b. participation in a felony, riot or insurrection; or

c. service in the armed forces or units auxiliary thereto; or

d. suicide (while sane or insane), attempted suicide or intentionally self-inflicted injury; or

5. For treatment provided in a government facility (unless otherwise required by law), services for which benefits are available under Medicare or other governmental program (except Medicaid), any state or federal workers' compensation, employer's liability or occupational disease law, or any motor vehicle no-fault law; or

6. For services provided by a Family Member; or

7. For care received outside of the United States or its territories.

VIII. Policy Reductions

The Monthly Incidental Expense Benefit Payable under the policy will be reduced by any Social Insurance Benefits payable for the Covered Insured.

IX. Pre-Existing Condition Limitation

The policy will not pay benefits for a Pre-Existing Condition if it was not disclosed on the application. Pre-Existing Condition means a sickness or physical condition for which prior to the Effective Date:

1. Symptoms existed that would cause an ordinarily prudent person to seek diagnosis, care or treatment; or

2. Medical advice or treatment was recommended by or received from a Physician.

Also, the policy will to pay benefits for any loss excluded by name or specific description.

Obviously, numerous modifications and variations of the present invention are possible in light of the above teachings. The invention may be practiced as a stand-alone policy or as a rider to a different type of policy. Variations to the specific benefits, the monetary amounts of benefits, and the cost of coverage for benefits, varied based upon economic, actuarial, medical and market criteria, are possible in accordance with the invention. Accordingly, it is understood that other embodiments of the invention are possible in the light of the above teachings.

1. A method of underwriting a children's insurance policy, comprising:
a. at least one payment of a premium made on behalf of a covered insured to an underwriter;
b. the underwriter issuing an insurance policy, wherein if a disabling event befalls a covered insured, the underwriter shall issue at least one benefit to the covered insured.

3. The method of claim 1 wherein the covered insured is a minor.

4. The method of claim 1 wherein the covered insured becoming functionally disabled constitutes a disabling event.

5. The method of claim 1 wherein the covered insured becoming presumptively disabled constitutes a disabling event.

6. The method of claim 1 wherein the benefit to the covered insured includes a monetary stipend, if a disability befalls the covered insured.

7. The method of claim 1 wherein the benefit to the covered insured includes a monetary stipend for the cost of nursing home care for the covered insured, if a disability of the covered insured necessitates such care.

8. The method of claim 1 wherein the benefit to the covered insured includes a monetary stipend for the cost of home health care for the covered insured, if a disability of the covered insured necessitates such care.

9. The method of claim 7 wherein the monetary stipend is paid for a predetermined period of time.

10. The method of claim 1 wherein the benefit to the covered insured includes a monetary stipend for the cost of home tutoring of the covered insured, if a disability of the covered insured necessitates such care.

11. The method of claim 1 wherein the benefit to the covered insured includes a monetary stipend for the cost of training an individual to act as a caregiver for the covered insured in the covered insured's home.

12. The method of claim 10 wherein the monetary stipend may not exceed a predetermined amount.

13. The method of claim 1 wherein the benefit to the covered insured includes a monetary stipend for the cost of supportive equipment for the covered insured, if a disability of the covered insured necessitates such equipment.

14. The method of claim 12 wherein the monetary stipend may not exceed a predetermined amount.

15. The method of claim 1 wherein the benefit to the covered insured includes a monetary stipend for the cost of a major disabling event, is such a disabling event befalls the covered insured.

16. The method of claim 14 wherein the covered insured having a major organ transplant constitutes a major disabling event.

17. The method of claim 14 wherein the monetary stipend may not exceed a predetermined amount.

18. The method of claim 14 wherein the monetary stipend may only be paid to the covered insured one time.

19. The method of claim 1 wherein the benefit to the covered insured includes a second monetary stipend if the covered insured has received the monthly stipend for a disability having befallen the covered insured, if the covered insured returns to school.

20. The method of claim 1 wherein the benefit to the covered insured includes a second monetary stipend if the covered insured has received the monthly stipend for a disability having befallen the covered insured, if the covered insured returns to employment.

21. The method of claim 1 wherein the underwriter may not cancel the policy while the at least one premium payment is renewed on behalf of the covered insured.

22. The method of claim 1 wherein the policy is available to a covered insured between the ages of 6 months and 18 years.

23. The method of claim 21 wherein the policy may be extended until the covered insured reaches the age of 65.

24. The method of claim 1 wherein a lifetime elimination period must be satisfied before the underwriter must issue a benefit to the covered insured.

25. The method of claim 1 wherein the underwriter may reduce benefits by the amount of any social insurance benefits paid to the covered insured.

26. The method of claim 1 wherein the underwriter shall not pay benefits if the covered insured has a pre-existing condition that is not disclosed to the underwriter at the policy is underwritten.

27. A children's insurance policy, the payment of at least a benefit by an underwriter to a covered insured when a disabling event befalls a covered insured and at least one payment of a premium is made on behalf of the covered insured.
